(19) United States
(12) Patent Application Publication
(10) Pub. No.: US 2010/0004945 A1
(43) Pub. Date: Jan. 7, 2010

(54) COMPUTER IMPLEMENTED METHODS, SYSTEMS, AND APPARATUS FOR GENERATING AND UTILIZING HEALTH OUTCOMES INDICES AND FINANCIAL DERIVATIVE INSTRUMENTS BASED ON THE INDICES

(75) Inventors: Gerasimos Petratos, New York, NY (US); Efthimios Parasidis, Astoria, NY (US)

Correspondence Address: FOLEY HOAG, LLP;PATENT GROUP, WORLD TRADE CENTER WEST, 155 SEAPORT BLVD, BOSTON, MA, 02110, US

(73) Assignee: Global Health Outcomes, Inc., New York, NY (US)

(21) Appl. No.: 12/495,003

(22) Filed: Jun. 30, 2009

Related U.S. Application Data
(60) Provisional application No. 61/077,267, filed on Jul. 1, 2008.

(51) Int. Cl. G06Q 50/00; G06N 5/02; G06Q 40/00

(52) U.S. Cl. 705/2; 706/52; 705/37; 705/36 R

(57) ABSTRACT

A computer-implemented method, a computer program product, and a computer system are provided for generating and utilizing a health outcome index for a given research interest area and a given population. The computer-implemented method includes the steps of: (a) receiving data relating to one or more given criteria pertinent to the research interest area; (b) calculating a health outcomes index using one or more computer processes applying a given formula to the data relating to the one or more given criteria, said given formula including assignment of relative weights to said one or more criteria; (c) outputting the health outcome index; and (d) periodically repeating steps (a) through (c).

### CROSS REFERENCE TO RELATED APPLICATION

The present application is based on and claims priority from U.S. Provisional Patent Application No. 61/077,267 filed on Jul. 1, 2008 and entitled “System, Method And Apparatus For Creating A Health Outcome Commodity Index Or Indices And Creating A Financial Derivative Instrument Or Instruments Based On The Index Or Indices,” which is incorporated herein by reference.

### BACKGROUND

The present application generally relates to the fields of healthcare and finance. More particularly, it relates to computer implemented analysis and transformation of healthcare data to reveal relevant health outcomes at the population-level of patients and creating health outcomes indices (“HOIs”) as well as financial derivative instruments that are based upon the indices, which may be utilized to, e.g., capture value movements, hedge against risk, assist in business decisions, assist in health care related decisions, and/or establish a health futures market.

Health status measures for populations have been discussed in the medical and health economics literature since the 1960s. Mortality rates, when used to reflect health status, lack sensitivity; morbidity indices and quality of life indices were later developed and deemed, by some, to be more inclusive measures. In the field of health care, there exists a need not only to measure individual health gains, but also a common unit of measurement which is valid across individuals to measure the total health gain (or loss) for a given population. The ability to measure population-based health outcomes is meaningful to both society and the health industry. For instance, as just one example, if a common scale, or index, can be widely used across the major health care stakeholders (such as government, patient advocacy groups, life sciences companies, managed care organizations, etc.), then the treatment of both individuals and certain diseased populations can become more targeted by health care providers, investments and quality improvement specialists. As an example, the lack of a detailed measurement of health status for minority communities in the United States has contributed to inconsistent treatment and prevention efforts of diseases.

The importance of a health outcomes measure is seen by looking at National Health Expenditures from 1960-2006, where public and private sources of expenditures have increased steadily over time with an overall rise from 5.2 to 16% as a percent of GDP. However, there are no published or usable measures over the equivalent period of time for assessing whether, and how, health outcomes have improved. Such measures could serve as a barometer to measure health outcomes and explain how the increase in expenditures in health is impacting investments and, in turn, impacting health outcomes. Without regularly supplied health outcomes measures, major health care stakeholders have difficulty in accurately measuring, predicting, and/or managing the impact of expenditures on the health of populations. Certain minority populations are particularly vulnerable and affected by this lack of information, since the new products and services to treat and prevent diseases may not be developed with their needs in mind.

The current health care forecasting models and/or indices are limited in scope and based primarily on national income of health care consumption, as well as general statistics from numerous sources that focus on financial accounts for costs grouped under wide baskets such as “Hospital,” “Drugs,” and “Physicians.” The major chronic diseases and sub-diseases that account for a large proportion of the total health care of the U.S. need to have their outcomes measured over time so that the health care industry can compare these diseases in uniform manner and allocate resources accurately.

Currently, and in recent years, the United States has spent approximately $2 trillion U.S. dollars annually on healthcare, which comprises approximately 16% of GDP. These amounts are growing at rates that are no longer sustainable by the public and private sectors. Many public and private employers of all sizes, health insurance companies, unions, and insured and non-insured individuals are finding it difficult to manage and predict healthcare costs, while the health care industry is experiencing difficulty in making decisions for maintaining existing or introducing new products and services. Institutional and individual investors that invest and own hundreds of billions of dollars (and possibly trillions of dollars, if sovereign wealth funds and pension funds are included) of equity in the healthcare sector are making daily investment decisions based on a number of factors, including but not limited to, earnings, management changes, reimbursement, sales, health plans membership levels, or successes and failure in discovery or launch of new health product or technology, all of which are tied in some way to economic, clinical or humanistic health outcomes. If patients do not achieve a certain level of positive health outcomes, there is evidence to suggest that they lose occupational, social and family productivity, discontinue treatment, seek alternative health care, file malpractice claims, and/or become disabled. Each of these contributes to the rising cost of healthcare. Moreover, due to the rising costs of healthcare and the lack of an objective, quantitative method to value health outcomes, there is a substantial risk for payer-based decisions to cut products and services without knowing what the effects of the cuts will be on patients' health.

According to Congressional Budget Office projections, without any changes in federal law, total spending on health care will rise from being 16% of the economy in 2007 to being 25% in 2025 and almost 50% in 2082. In addition, net federal spending on Medicare and Medicaid will rise from being 4.1% of the economy to being almost 20% over the same time period. The primary driver of future costs will be the increasing cost for treating each beneficiary, rather than the increased number of older beneficiaries.

Embedded in this fundamental long-term fiscal challenge is how to contain cost without adversely affecting health outcomes. However, per capita health care spending varies widely across the United States, and the substantial variation in cost per beneficiary is not correlated with positive health outcomes. In essence, health care cost—$2 trillion spent annually on healthcare in the United States—does not necessarily produce better health outcomes. In this respect, expenditures alone are an insufficient gauge for institutional (both public and private) and individual investors.

The $2 trillion amount does not capture the additional trillions of dollars that the healthcare sector invests annually on research and development to improve healthcare, nor does it capture equity purchased by institutional and individual investors of healthcare stocks and bonds on the open market. Future investments and the landscape of healthcare expenditures are changing dramatically, with investments targeting only those treatments that have the most improved outcomes and a proven track-record with respect to disease management. Heightened attention is being placed on preventative care, comparative effectiveness, and utilization management. Each of these areas requires a reliable gauge of health outcomes to justify the investment required to prevent and/or treat a disease. More focus is also being placed on increasing the alternatives for economic therapies, by using pharmaceuticals, diagnostics, and medical devices, as opposed to costly hospital stays and surgeries. For instance, recently, the United States spent approximately $300 billion U.S. dollars on pharmaceuticals, which represents a significant increase over the prior year for both specialty diseases (such as rheumatoid arthritis) and primary care (such as asthma and cardiovascular disease). Nevertheless due to reimbursement cuts, implementation of diagnostic related groups and pay-for-performance that seek to discharge patients much earlier from institutions, there has also been a steady trend in re-hospitalizations and medical errors. As such, these are costly alternatives that also impact health outcomes.

In addition, there is significant risk and competition involved in developing products and services for healthcare. For the biopharmaceutical industry, the overall success rate for medicines which begin human testing is approximately 11%. The development of many new medicines is stopped due to economics (such as where anticipated costs of development are greater than anticipated discounted revenues), as well as changing market conditions (such as where competitor products are introduced sooner, or where safety risks of a drug class limit future use). Accordingly, companies need to be able to hedge against such conditions so that money lost in failed development projects, or when a drug is pulled from the market, is recovered and used to fund new drug projects.

### BRIEF SUMMARY OF EMBODIMENTS OF THE INVENTION

In accordance with one or more embodiments of the invention, a computer-implemented method is provided of generating and utilizing a health outcome index for a given research interest area and a given population. The computer-implemented method includes the steps of: (a) receiving data relating to one or more given criteria pertinent to the research interest area; (b) calculating a health outcomes index using one or more computer processes applying a given formula to the data relating to the one or more given criteria, said given formula including assignment of relative weights to said one or more criteria; (c) outputting the health outcome index; and (d) periodically repeating steps (a) through (c).

In accordance with one or more embodiments of the invention, a computer program product is provided for generating and utilizing a health outcome index for a given research interest area and a given population. The computer program product resides on a computer readable medium having a plurality of instructions stored thereon which, when executed by a processor, cause that processor to: (a) receive data relating to one or more given criteria pertinent to the research interest area; (b) calculate a health outcomes index using one or more computer processes applying a given formula to the data relating to the one or more given criteria, said given formula including assignment of relative weights to said one or more criteria; (c) output the health outcome index; and (d) periodically repeat (a) through (c).

In accordance with one or more embodiments of the invention a computer system is provided for generating and utilizing a health outcome index for a given research interest area and a given population. The computer system includes: an input for receiving data relating to one or more given criteria pertinent to the research interest area; one or more processors for calculating a health outcomes index by applying a given formula to the data relating to the one or more given criteria, said given formula including assignment of relative weights to said one or more criteria; and an output for outputting the health outcome index.

Various embodiments of the invention are provided in the following detailed description. As will be realized, the invention is capable of other and different embodiments, and its several details may be capable of modifications in various respects, all without departing from the invention. Accordingly, the drawings and description are to be regarded as illustrative in nature and not in a restrictive or limiting sense, with the scope of the application being indicated in the claims.

### BRIEF DESCRIPTION OF THE DRAWINGS

FIG. 1 is a flow chart generally depicting a method for creating a HOI in accordance with one or more embodiments of the invention.

FIG. 2 is a flow chart generally depicting a method by which to devise the relevant percentage for each factor of a particular HOI in accordance with one or more embodiments of the invention.

FIG. 3 is a tabular depiction of particular components that may comprise the economic data portion of a particular HOI in accordance with one or more embodiments of the invention.

FIG. 4 is a tabular depiction of particular components that may comprise the clinical data portion of a particular HOI in accordance with one or more embodiments of the invention.

FIG. 5 is a tabular depiction of particular components that may comprise the humanistic data portion of a particular HOI in accordance with one or more embodiments of the invention.

FIG. 6 is a flow chart generally depicting a method for creating a HOI financial derivative instrument in accordance with one or more embodiments of the invention.

FIG. 7 is a schematic illustration generally depicting a system and apparatus by which to create a HOI in accordance with one or more embodiments of the invention.

FIG. 8 is a schematic illustration generally depicting a system and apparatus by which to create a HOI financial derivative instrument in accordance with one or more embodiments of the invention.

FIG. 9 is a tabular depiction generally depicting exemplary values, along with percent change from previous measurement, for the economic, clinical, and humanistic outcomes for various diseases. FIG. 9 further depicts a HOI for various diseases that is based on a combination of each of the economic, clinical, and humanistic outcomes.

FIG. 10 is an overlay of two graphs, a time series of an exemplary HOI for Diabetes and graph showing the derivative of the Diabetes HOI as if it were to be traded on an exchange.

FIG. 11 is a schematic illustration generally depicting a process for creating and utilizing a HOI.

FIG. 12 is a table generally depicting the components of an exemplary HOI for Diabetes.

### DETAILED DESCRIPTION

As described in further detail below, the present application is generally directed to computer implemented methods, systems, and apparatus for creating and utilizing health outcomes indices (“HOIs”), and creating one or more financial derivative instruments that are based upon the indices, which may be utilized, e.g., to capture value movements, hedge against risk, assist in business decisions, assist in health care related decisions, and/or establish a health futures market.

In accordance with one or more embodiments, the methodology for creating HOIs includes the application of population-based statistical models that have been specifically developed to quantify currently available medical information and create accurate benchmarks for the measurement of the burden of disease over time. A population-based methodology can be used to prospectively identify, stratify, and regularly measure trends and patterns for health outcomes. One exemplary application is to improve the health of minority and other populations through data-driven approaches that allow for the timely aggregation of clinically relevant information that can then be analyzed and presented to health care providers, patients, life sciences companies, and payers so that they can use the information for tailoring therapies and managing diseases in these communities.

In accordance with one or more embodiments, market conditions of health outcomes of disease can be gauged as an informational and analytics product instead of a service. The service model currently supports healthcare industry companies to receive medical information on a project-by-project basis from vendors who aggregate and report on their data. Although the service model is useful on a project-by-project basis to tailor answers to questions about diseases, an objective gauge across the industry in the form of a pre-specified product, or index, does not exist. HOI fills the gap that exists by being a product as opposed to a service, and providing the level of detail that is necessary for health care industry organizations to accurately track and target relevant disease outcomes over time. In addition, HOI provides for an improved method of measuring health outcomes that includes clinical, economic and/or humanistic components, which, in turn, allows for an improved method of conducting comparative effectiveness research.

By way of first example, a HOI may be organized by disease (which includes, but is not limited to, diabetes, asthma, breast cancer, Alzheimer's disease or coronary artery disease), so that it matches the healthcare industry's need to identify, measure and/or improve outcomes of a specific disease.

By way of second example, a HOI may be organized by therapeutic area (which includes, but is not limited to, inflammatory diseases, cancers, metabolic diseases, infectious diseases, nervous system diseases or cardiovascular diseases), so that it matches the healthcare industry's need to identify, measure and/or improve outcomes by therapeutic area.

By way of third example, a HOI may be organized by drug class (which includes, but is not limited to, pain medications, COX-2 inhibitors, anti-infectives, anti-virals, hormonal agents, cancer agents, monoclonal antibodies, polyclonal antibodies, anti-sense RNA or immune-modulating agents), so that it matches the healthcare industry's need to measure outcomes of a specific drug class.

By way of fourth example, a HOI may be organized by genotype, so that it matches the healthcare industry's need to measure outcomes of a specific genotype.

By way of fifth example, a HOI may be organized by RNA-type, so that it matches the healthcare industry's need to measure outcomes of a specific RNA-type.

By way of sixth example, a HOI may be organized by protein-type, so that it matches the healthcare industry's need to measure outcomes of a specific protein-type.

By way of seventh example, a HOI may be organized by medical or biologic technology (which includes, but is not limited to, gene therapy, stem cell treatment, nanotechnology, neural circuitry treatment or neural enhancement), so that it matches the healthcare industry's need to measure outcomes of a specific medical or biological technology.

For each of these and other examples, as well as any possible technique for creating a HOI, the HOI may be tailored by locality (for instance, by country, continent, state, municipality, city, or any specified geographic region). Additionally, the HOI may be tailored to a sample population, including, but not limited to, a particular geographic region, industry, company or ethnic group.

For instance, there may be a HOI for diabetes (United States), a separate HOI for diabetes (Europe), a separate HOI for diabetes (France), and/or a separate HOI for diabetes (Japan). Similarly, there may be a HOI for diabetes (Pfizer) and/or a separate HOI for diabetes (Aetna). Likewise, there may be a HOI for diabetes (Pfizer—United States), as well as a separate HOI for diabetes (Pfizer—France). Moreover, there may be a HOI for diabetes (African Americans in the United States), and/or a separate HOI for diabetes (people living in the Caribbean of African decent). Accordingly, there are numerous combinations of HOIs that are contemplated in accordance with various embodiments described herein.

Each HOI is preferably transparent, allowing for individuals to understand the general formula used to generate a particular HOI. Each HOI is preferably comprised of one number, which is derived using one or more criteria and provides for a population-based identification and measurement of HOI over time. In accordance with one or more embodiments, the criteria can include one or some combination of the following: (1) economic outcomes, as, for instance, is measured by direct and indirect costs of medical practice and health care utilization data; (2) clinical outcomes, as, for instance, are measured through health insurance claims, electronic medical record data, prescription data and lab data; and (3) humanistic outcomes, as, for instance, are measured through survey instruments administered to patients, or their caregivers, to determine quality of life, symptoms and/or productivity. Depending on the relative importance and availability of data for each criterion to the underlying measurement of a particular HOI, each HOI may utilize a differing percentage of each of the three criteria in the range of 0-100%. Depending on the particular make-up of an individual HOI, the three aforementioned criteria may be mathematically combined to produce one number that serves as the HOI. Mathematical combinations envisioned by one or more embodiments may include mathematical operations including addition, subtraction, percent weight, numerical change from baseline, percent change from baseline, and/or any combination of the above. In addition, such mathematical combinations may also include derivations from an algorithm that is specifically tailored to a particular HOI, or any mathematical formula that may be relevant or applicable to a particular HOI.

By way of first example, a HOI for breast cancer in the United States may be based on 30% economic outcomes, 35% clinical outcomes and 35% humanistic outcomes. By way of second example, a HOI for asthma in Sweden may be based on 10% economic outcomes, 30% clinical outcomes and 60% humanistic outcomes. By way of third example, a HOI for rheumatoid arthritis by drug class may be entirely based on clinical outcomes (0% economic outcomes, 0% humanistic outcomes, and 100% clinical outcomes). The particular percentage breakdown of the components that comprise a HOI will be based upon an individualized formula derived from data and the individual goals and purposes underlying the HOI at issue.

In addition to the foregoing population-based methodology, each HOI may be utilized by an individual, a health care payer, and/or a health care provider to assess, compare and/or analyze the treatment method that should be followed by a particular individual. Each HOI may also be utilized, from a comparative effectiveness standpoint, at either the micro or macro levels, in proposing or rendering treatment and/or reimbursement decisions.

Each HOI is based on real-world clinical evaluations of individuals. For each individual, the clinical evaluation is a measurement of chemical properties in that individual's body. The chemical properties are then identified to clinicians as quantitative or qualitative representations. Health care providers then use these quantitative and qualitative representations to diagnose individual patients and make health care decisions. Each HOI aggregates these representations, applies statistical modeling and produces a summary value, or index, that tracks changes in clinical evaluations. As such, each HOI transforms raw medical data from individuals into a dynamic index that can be used to measure and track the burden of disease over time. Moreover, each HOI may then be used in making decisions by various players in the health care industry, such as payers, providers and patients, at both the micro and macro levels.

Methods to enhance the validity of the data and statistical modeling to control confounding and reduce bias can include propensity scoring, stratification, inverse probability weighting, use of instrument variable and other direct and indirect simulation approaches.

With the HOI methodology, what is captured in the indices is sufficient to capture the true changes for the larger population. By way of example, changes from period-to-period in the index capture the direction and magnitude of change in the health of the population or the cost burden of treating the disease. The indices themselves can be constructed by combining information from multiple sources but do not necessarily have to include all possible sources and types of economic, clinical or humanistic data.

The three types of outcome types, Economic, Clinical, and Humanistic, each have a non-arbitrary way for combining different types of data. For instance, an economic outcomes index may include cost data, a clinical outcomes index may include laboratory tests and prescriptions and clinical findings, and a humanistic outcomes index may include answers to patient-reported questions on their overall quality of life and productivity. Data for each outcome type is selected with the underlying goal of permitting observation of the individual movement of the three outcomes components and the summary value of the index. Likewise, data must be appropriately selected and properly weighted so as to reduce, minimize, or eliminate the spurious fluctuation that may occur in the HOI values when new data are included in the formula.

Testing the behavior of the index, by simulating a historical period, is completed as part of the validation process used to create the index. For the production-level index, the values of the index can be updated as frequently as monthly, and preferably no less frequently than quarterly or yearly. As health care data becomes available at an increasingly more frequent rate, it is envisioned that daily, or real-time, updates to the index will be possible. Daily updates will also better meet the needs of the investment industry which conducts valuations, reacts to news events, and trades equity of companies on a daily basis.

In addition to the frequency of compiling and publishing the index, the time lag between the period to which the most recent update of the index applies, and the calendar period in which this update is produced and published is important. Moreover, because the potential costs of error are high, the quality control and testing process for a new value of the index needs to be robust. Hence, for a monthly index, the publication lag initially will likely be two to three months. It is anticipated that, with advancements in the art, this time lag will decrease, arriving at or close to the point where it is real-time.

By way of example, in accordance with one or more embodiments, the following sequential process may be used to prepare a HOI:

1. Prepare population-based statistical model or models that describe the proposed HOI and determine the data needs for each component type. Through working with several epidemiology and clinical consultants, an algorithm is created for weighting each relevant variable or group of data that is consistent with the intended measurement of the economic, clinical and humanistic criteria. This algorithm may include a combination of medical and pharmacy claim utilization indicative of the underlying disease as well as claims identified with a diagnosis code for each disease to identify cases. The total diseased population is further divided into subpopulations to indicate patient severity, including diagnosis with controlled or uncontrolled disease and relevant co-morbid conditions. For example, for diabetes, co-morbid conditions may include nephropathy, peripheral neuropathy, stroke, hypertension, dyslipidemia, retinopathy, coronary artery disease, congestive heart failure, and general diabetes. Output results may include a measure of the size of the population and its component subpopulations and may include detail by age, gender, region, ethnicity and/or race.

2. Identify sources for all the data needs and determine data availability, time lag, and sample sizes.

3. Construct historical values for HOI by identifying relevant variables from multiple sources, including demographic measures, incidence and prevalence, overall morbidity, overall healthcare utilization, disease-specific tests, and disease-related morbid outcomes.

4. Using broad national databases, such as National Health and Nutrition Examination Survey (NHANES) and Medicare samples, compare the results of the HOI values to another sample of insurance claims and/or Electronic Health Record data.

5. Test the index by developing validation methods, including a regression model that takes the variables and values from one retrospective dataset and compares with another sample.

6. Create communications required to disseminate the HOI in peer-reviewed journals, print material, promotional videos and the Internet.

In addition to creating any number of HOIs, in accordance with one or more embodiments, a system, method and apparatus is provided for creating any number of financial derivative instruments that may be based on each HOI. By utilizing the financial derivate instrument or instruments, an entity or individual can hedge against fluctuations in health outcomes. Such health outcomes measure the burden of disease for a population over time. By way of first example, a futures contract may be based upon a HOI. The futures contract may then be traded on a futures market or other exchange. The placement of HOI futures contracts on a futures market or other exchange will permit the trading of contracts in health outcomes. By way of second example, the HOI itself may serve as a financial instrument that may be directly traded, traded through subscription or invested in by any means as known in the art.

A number of parties can benefit from trading on these HOI financial derivative instruments. By way of first example, a pharmaceutical company may purchase a futures contract to hedge their risk for projects which are economically risky to develop and are subject to the risk of changing market conditions, such as competition, decreased payments for expensive medicines and safety risks once the medicine is on the market. The futures exchange facilitates the spreading of risk for these risky projects to speculators and other parties in the open market. For instance, instead of today's environment where a large pharmaceutical company may decide to stop development of an economically risky development project for a new medication, an environment where HOI futures contracts exists can allow the major health insurers to promote the further development of that project (by purchasing appropriate futures contracts in the HOI, which will drive up the value of the futures HOI compared with the actual, measured value, which may cause the pharmaceutical company to change its valuation of the project with respect to its impact on the market. Therefore, the pharmaceutical company may be able to justify its expenditures on a project due to anticipated increased earning potential and/or demand for a medicine, with the result that a competitor may reduce costs and increase the treatment options for patients. The purchase of futures contracts which are long for that particular HOI will increase the value for the contracts of a particular disease's HOI, thus setting the value of what the outcomes for a particular disease during a particular time period will be worth. Therefore, the capital markets are utilized to gauge the introduction of new therapies based on increasing the positive health outcomes for each HOI. Each individual industry player may benefit from this system due to their reduced risk (since free-market players will assume risk) and overall improved chances for successful projects.

By way of second example, an investor, such as a hedge fund or sovereign wealth fund, may require that its investment, such as a pharmaceutical or biotech company, purchase HOI financial derivative instruments in order to hedge against the failure of a particular product or project. This, in essence, provides the investor with a level of security as to their investment, and further serves as a type of insurance policy.

By way of third example, a managed care organization that insures the health of an employer's workers can purchase HOI financial derivatives to hedge against exposure to a high cost (and/or high risk) group. For instance, the managed care organization could purchase futures contracts that are short the Economic Outcome Type of one or multiple disease HOI derivatives (meaning that the organization bets that costs will become more expensive reflecting poorer cost outcomes), to ensure that if high health costs of the covered lives exceed the managed care organization's budget, their hedge in a Health Futures market will pay them the money that results in the change of the derivative's value (assuming that the managed care organization's costs are reflective of the overall market economic outcomes costs).

Participants of the HOI futures market can be commercial or institutional healthcare organizations who want the value of their assets to increase and want to limit, if possible, any loss in value associated with changes in disease state or failed healthcare products. In addition, hedgers may use the HOI futures market to take a position that will reduce the risk of financial loss in their assets due to a change in index value (which is indicated by a change in HOI itself). Other participants can be speculators who hope to profit from changes in the price of the futures or option contract that is tied to HOI.

The following examples outline some of the various hedging positions of the major healthcare industry players: (1) Life Sciences (which include, but are not limited to, pharmaceutical and biotech companies) may seek out improved outcomes before the launch of a new drug and worsened outcomes after a drug is successfully on the market; (2) Payers (which include, but are not limited to, insurance companies and governments): may seek out worsened outcomes for the patients they are covering and improved outcomes for patients they are not covering; and (3) Providers (which include, but are not limited to, large medical centers and clinics): may seek out worsened outcomes for patients they are treating and improved outcomes for patients they are not treating.

A HOI futures contract also satisfies speculators who can take long or short positions for a particular disease across the industry, or in accordance with any combination discussed herein, without being forced to invest in a specific company. This may behoove a speculator who would normally be precluded from investing in a specific company due to his close association as an employee, or other interested party, but who still wants to take a position for a particular HOI. For instance, a speculator who shorted an index for Alzheimer's, by betting that no effective treatments for Alzheimer's disease would be realized due to the poor selection of drug targets by Life Sciences companies, would have achieved particularly beneficial results. Similarly, a HOI futures contact could be used to bet on the improvement of outcomes for diseases treatable by stem cell technology (such as multiple sclerosis, bronchial asthma and sickle cell anemia) due to the new legislation promoting this therapy.

By way of example, when a new product (such as a drug, medical device or disease management program) enters the market with a HOI, there exists a hedge that can be made based on whether it is beneficial for a company to hedge against improved or worsened outcomes in the diseases that the company's products or services are intended to treat.

Although HOI futures contracts can be used for speculating, they can also be designed as vehicles for hedging and risk management. Hedgers who can benefit from the use of HOI futures contracts include, but are not limited to: (1) project and portfolio managers negotiating budgets within health industry companies; (2) business developers and licensing managers negotiating collaborations; (3) investors who buy and sell companies; and (4) analysts working in investment banks.

A tenet of HOI and HOI financial derivative instruments is that health outcomes will, for all diseases or treatment methods, change over time (as indicated by an increase or decrease in the value of a particular HOI). The reason HOIs have value to the institutions and parties that use them, is that they measure the increase or decrease in the status of a health outcome through a standard, scientifically based formula that is specific to each major disease and therapeutic area. Since many institutions and individuals in today's global society are involved with products, services, philanthropy, etc. to improve health, HOIs can be used as a gauge to measure the impact of money invested in certain diseases.

Futures contracts based on a HOI can be used to predict the future status of diseases in terms of how patients with those diseases will fare in health outcomes. Such is permitted because investors who trade the futures contracts set the prices on the contracts. In the situation of a global health economy, patients and providers select countries and global regions in which to either receive or provide healthcare, respectively. This selection is based on the perceived outcomes in each region relative to the home region of patient or provider. For example, dentistry in India has recently improved dramatically and patients in the United States are traveling to India for expensive dental procedures which are cheaper in India with the same level of quality outcomes. Similarly, doctors from the United States are traveling to Brazil to treat patients with transplant needs since the clinical outcomes are low due to lack of trained surgeons but yet availability of organs, and the financial outcomes are high (meaning that the doctors will be compensated for their work). Moreover, futures contracts based on a HOI measure the money available and trading associated with health care by allowing investors to hedge their development of innovative healthcare products by purchasing contracts which define the time period in which a particular HOI will change in value, and to what extent it changes.

HOIs and HOI financial derivative instruments serve as reliable indicators of health to measure the relative state of diseases, treatment methods or drugs, or whatever the basis of the HOI may be, over time in the three areas that are demanded by investors and the public: economic, clinical and humanistic outcomes.

In accordance with one or more embodiments, a computer apparatus is provided to create a HOI or HOI financial derivative instrument. The apparatus is comprised of a computing device capable of having data being inputted into the device. For instance, data related to the three components of a particular HOI—which includes economic data, clinical data and humanistic data—may be inputted into the computing device. The data may be inputted directly by a user of the computing device or through a link to an outside source or sources. For instance, the computing device may be linked to one or more distinct data sources, such as outside computing devices, which provide input data related to economic, clinical and humanistic data. The external devices may be linked to the computing device via any communications channel, such as the internet or other communications link.

Once the computing device has collected the external data, the device manipulates and transforms the data in such a way to create a particular HOI or HOI financial derivative instrument. The computing device then outputs a figure that represents the HOI or HOI financial derivate instrument. The output may be communicated, via any available means, to a third party. This output produces a tangible result and provides a useful purpose insofar as the computing device creates a figure by manipulating the data from the outside sources, the figure not being in existence prior to the manipulation by the computing device.

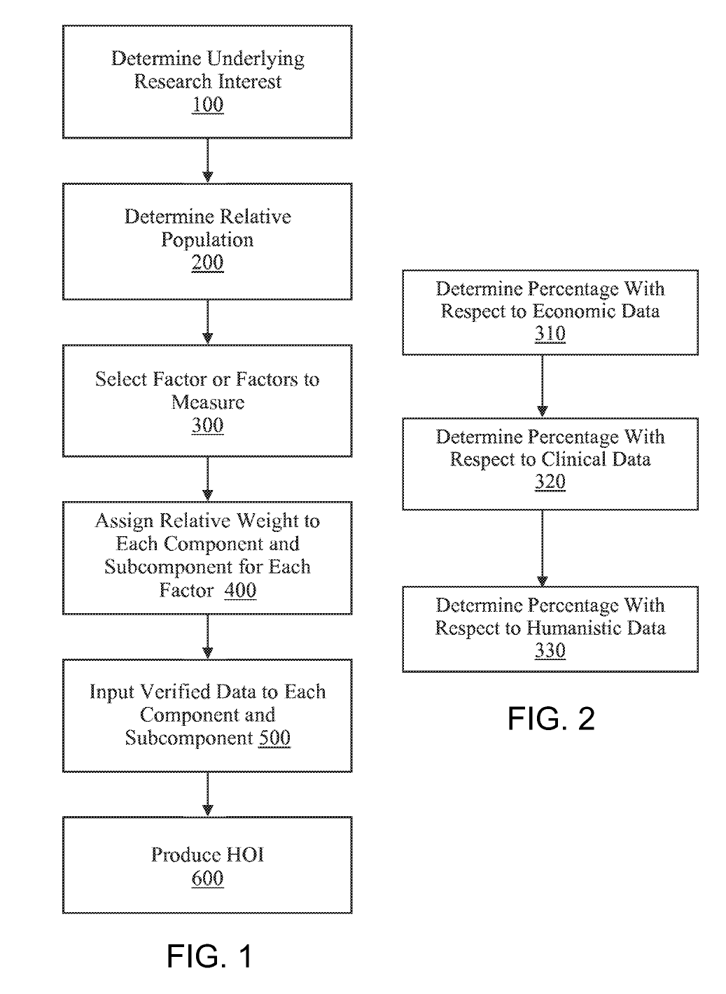

FIG. 1 illustrates an exemplary flowchart for creating a health outcome index (“HOI”) in accordance with one or more embodiments. Initially, at step 100, the underlying research interest is determined or identified. By way of first example, a HOI may be organized by disease (which includes, but is not limited to, diabetes, asthma, breast cancer, Alzheimer's disease or coronary artery disease), so that it matches the healthcare industry's need to measure outcomes of a specific disease. By way of second example, a HOI may be organized by therapeutic area (which includes, but is not limited to, inflammatory diseases, cancers, metabolic diseases, infectious diseases, nervous system diseases or cardiovascular diseases), so that it matches the healthcare industry's need to measure outcomes by therapeutic area. By way of third example, a HOI may be organized by drug class (which includes, but is not limited to, pain medications, COX-2 inhibitors, anti-infectives, anti-virals, hormonal agents, cancer agents, monoclonal antibodies, polyclonal antibodies, anti-sense RNA or immune-modulating agents), so that it matches the healthcare industry's need to measure outcomes of a specific drug class. By way of fourth example, a HOI may be organized by genotype, so that it matches the healthcare industry's need to measure outcomes of a specific genotype. By way of fifth example, a HOI may be organized by RNA-type, so that it matches the healthcare industry's need to measure outcomes of a specific RNA-type. By way of sixth example, a HOI may be organized by protein-type, so that it matches the healthcare industry's need to measure outcomes of a specific protein-type. By way of seventh example, a HOI may be organized by medical or biologic technology (which includes, but is not limited to, gene therapy, stem cell treatment, nanotechnology, neural circuitry treatment or neural enhancement), so that it matches the healthcare industry's need to measure outcomes of a specific medical or biologic technology.

Once the underlying research interest is determined or identified at step 100, the relative population is determined or identified at step 200. For instance, the population for a particular HOI may be tailored by locality (including, but not limited to, country, continent, state, municipality, city, or any specified geographic region). Similarly, the population for a particular HOI may be tailored to a sample population, including, but not limited to, a particular geographic region, industry, company or ethnic group.

Through steps 100 and 200, by way of example, a HOI may be desired for diabetes (United States), a separate HOI for diabetes (Europe), a separate HOI for diabetes (France) and/or a separate HOI for diabetes (Japan). Similarly, there may be a HOI for diabetes (Pfizer) and/or a separate HOI for diabetes (Aetna). Likewise, there may be a HOI for diabetes (Pfizer—United States), as well as a separate HOI for diabetes (Pfizer—France). Moreover, there may be a HOI for diabetes (African Americans in the United States), and/or a separate HOI for diabetes (people living in the Caribbean of African decent). Accordingly, there are numerous combinations of HOIs that are contemplated by the present invention.

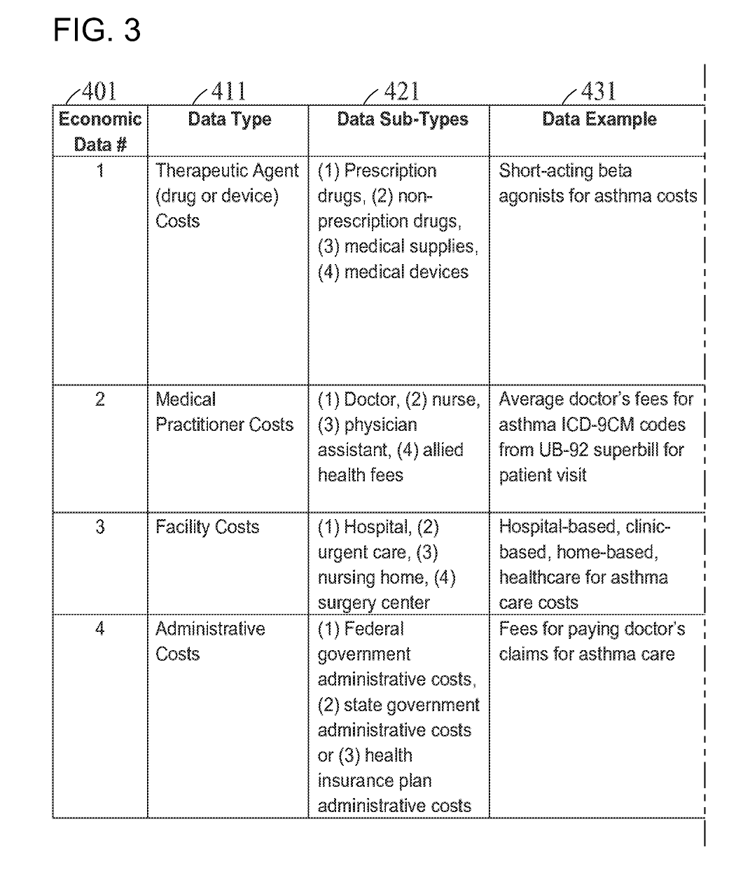

Each HOI is preferably transparent, allowing for individuals to understand the formula used to generate a particular HOI. As illustrated in step 300, and detailed in FIG. 2, each HOI is comprised of one number that is derived using one or more of the following three criteria: (1) economic data; (2) clinical data; and (3) humanistic data. Depending on the relative importance of each criterion to the underlying measurement of a particular HOI, each HOI may utilize a differing percentage of each of the three criteria as determined in steps 310, 320 and 330, in the range of 0-100%.

Illustrating step 300 and FIG. 2, by way of first example, a HOI for breast cancer in the United States may be based on 30% economic data, 35% clinical data and 35% humanistic data. As an equation, this may be represented as follows:

HOI=0.35 (economic data)+0.3 (clinical data)+0.35 (humanistic data)

By way of second example, a HOI for asthma in Sweden may be based on 10% economic data, 30% clinical data and 60% humanistic data. As an equation, this may be represented as follows:

HOI=0.1 (economic data)+0.3 (clinical data)+0.6 (humanistic data)

By way of third example, a HOI for rheumatoid arthritis by drug class may be entirely based on clinical data (0% economic data, 0% humanistic data and 100% clinical data). As an equation, this may be represented as follows:

HOI=1.0 (clinical data)

The particular percentage breakdown of the economic data, clinical data, and humanistic data components that comprise a HOI will be based upon an individualized formula derived from data and the individual goals and purposes underlying the HOI at issue.

Once the criteria for a particular HOI are determined, depending on the particular make-up of an individual HOI, at step 400, the criteria may be mathematically combined to produce one number that serves as the HOI. Mathematical combinations envisioned by the present invention may include addition, subtraction, percent weight, numerical change from baseline, percent change from baseline, and/or any combination of the above. In addition, such mathematical combinations may also include derivations from an algorithm that is specifically tailored to a particular HOI, or any mathematical formula that may be relevant or applicable to a particular HOI. By way of first example, the three criteria 310, 320 and 330 of a particular HOI may be combined as follows:

HOI=0.3 (clinical data)+0.35 (humanistic data)−0.35 (economic data)

By way of second example, the economic, clinical, and humanistic criteria of a particular HOI may be combined as follows:

HOI=[0.5(0.3 (clinical data 320))]+[3(0.35 (humanistic data 330))]−[2(0.35 (economic data 310))]

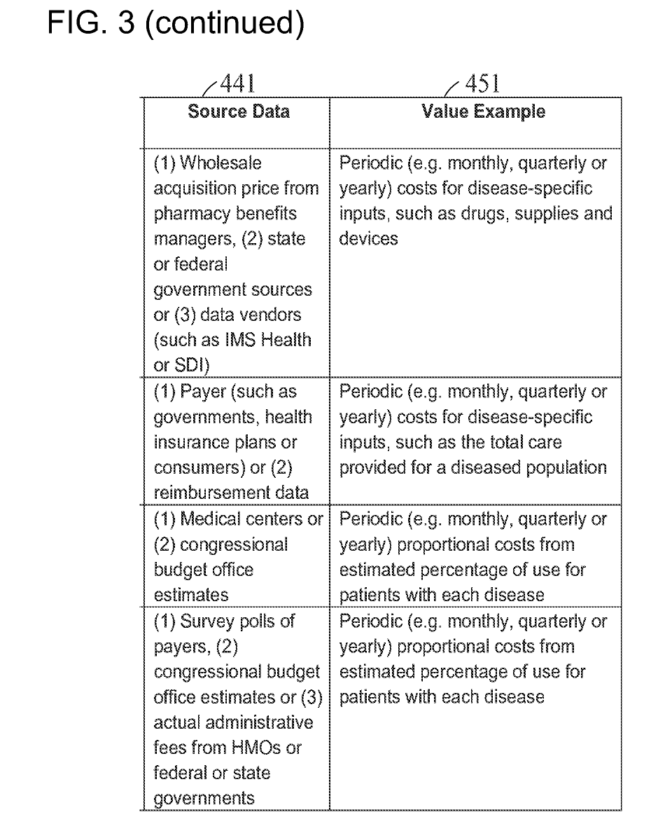

At the completion of step 400, at step 500, data for each of the three criteria is inputted. This data is obtained from reliable data sources, which is verified by a committee overseeing the particular HOI at issue. Such data sources include, but are not limited to, hospitals, research institutions, private or public health care companies, private or public insurance companies, national or local governments, international organizations, non-profit organizations, international agencies, and/or private or public data collection agencies. Referring to FIGS. 3-5, such data sources 441, 541 and 641 can include data vendors, governments, large medical centers and/or survey polls.

Referring to FIG. 3, financial data may include any number of data types 411. The data types 411 identified in FIG. 3 are intended to be exemplary. Such data types 411 include, but are not limited to, therapeutic agent cost, medical practitioner cost, facility costs and/or administrative costs. Accordingly, additional data types 411 may be included in the financial data component as may be appropriate for a particular HOI. These data types 411 may further be itemized by particular data sub-types 421.

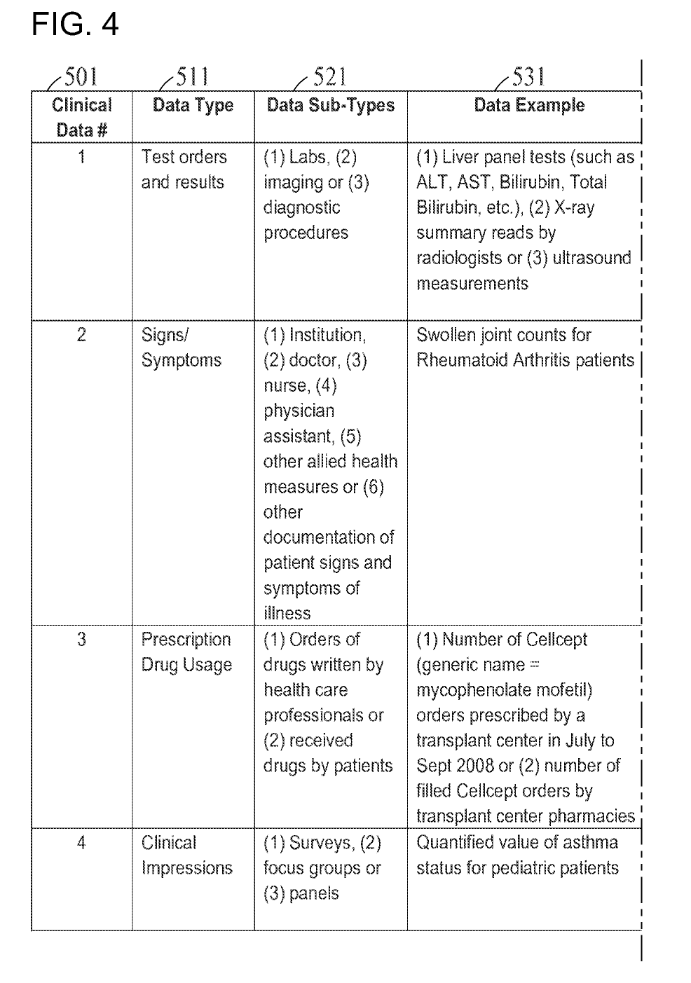

Referring to FIG. 4, clinical data may include any number of data types 511. The data types 511 identified in FIG. 4 are intended to be exemplary. Such data types 511 include, but are not limited to, test orders and results, signs/symptoms, prescription drug usage and/or clinical impressions. Accordingly, additional data types 511 may be included in the clinical data component as may be appropriate for a particular HOI. These data types 511 may further be itemized by particular data sub-types 521.

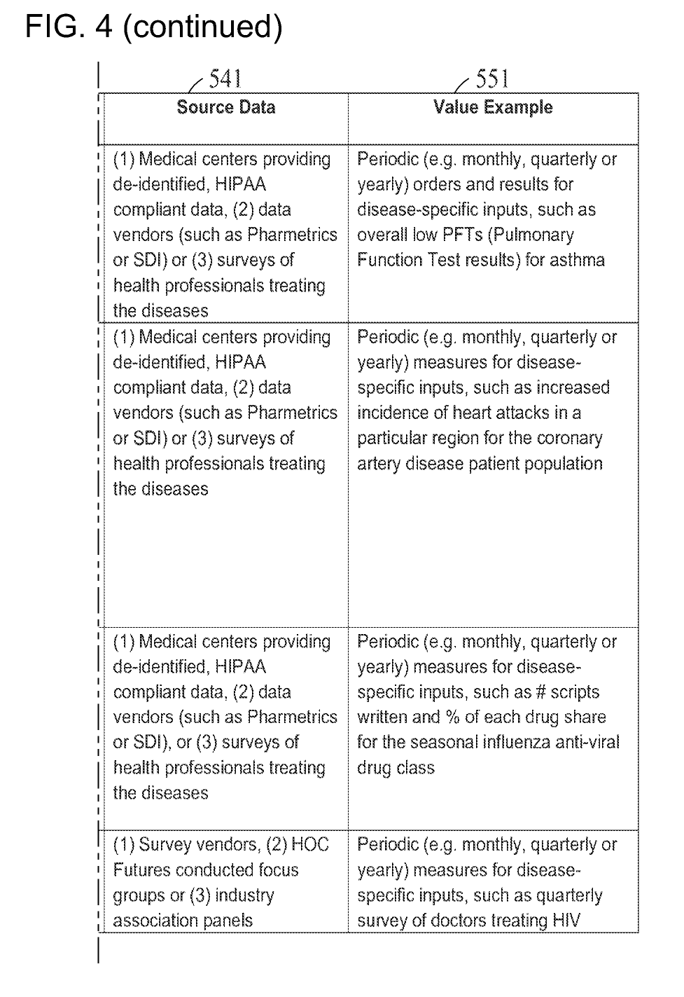

Referring to FIG. 5, humanistic data may include any number of data types 611. The data types 611 identified in FIG. 5 are intended to be exemplary. Such data types 611 include, but are not limited to, quality of life measures, symptoms and/or productivity. Accordingly, additional data types 611 may be included in the humanistic data component as may be appropriate for a particular HOI. These data types 611 may further be itemized by particular data sub-types 621.

FIGS. 3-5 provide examples of data 431, 531, and 631 for each of the economic, clinical and humanistic data components. These data examples 431, 531, and 631 are merely intended to be exemplary.

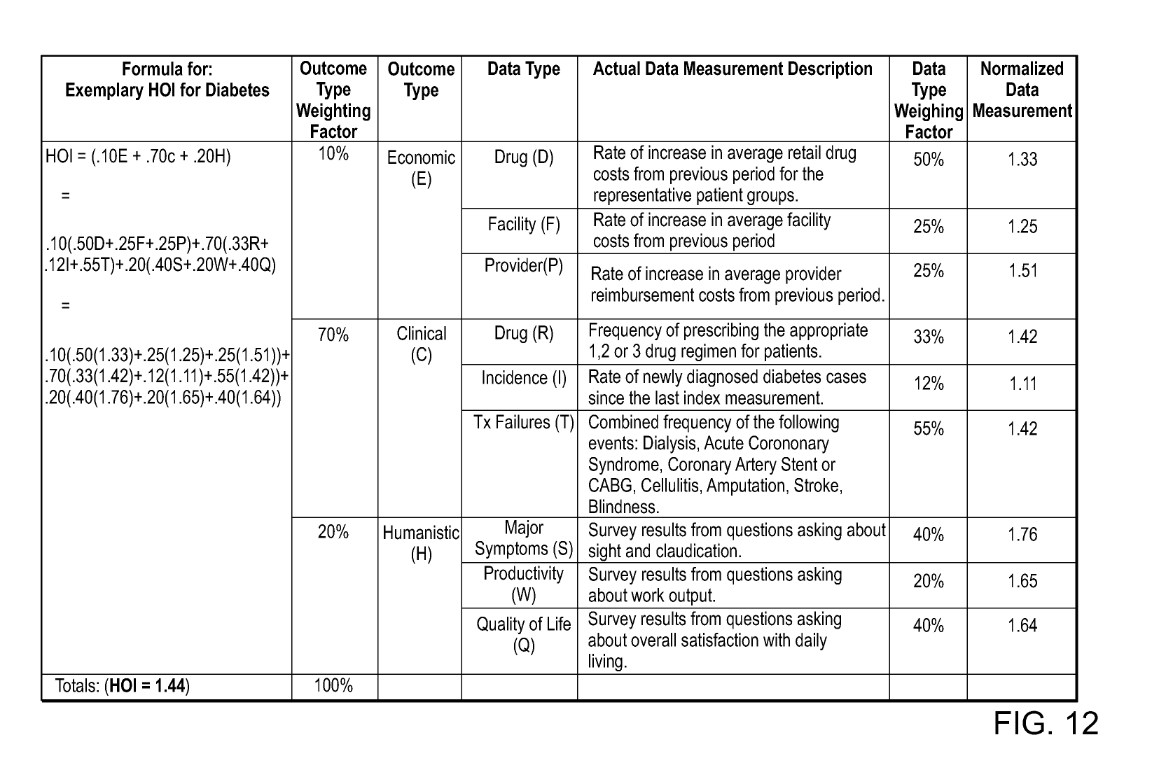

Once step 500 is satisfied, at step 600 the particular HOI is produced and may be utilized. As used herein, utilizing a HOI can include, e.g., outputting the HOI, transmitting the HOI to a third party, processing the HOI to generate a financial derivative instrument, using the HOI as a tradable financial instrument, using the HOI in a health-care decision making process, or using the HOI to evaluate health care options. To demonstrate how the real measurement of a HOI occurs, FIG. 12 depicts the components of an exemplary HOI for Diabetes. Each Outcome Type (Economic, Clinical and Humanistic) is given a weighting within the overall HOI formula based on an algorithm and expert panel categorization specific to each disease HOI (see column “Outcome Type Weighting Factor”). In addition, each Data Type (e.g., Drug, Facility, or Provider) is given a weighting within each Outcome Type based on an algorithm and expert panel categorization specific to each disease HOI (see column “Data Type Weighting Factor”). The algorithms referred to in this section are based on retrospective and prospective analysis of known information and its impact on the Outcome Type for a national sample of Diabetes data. (See columns “Formula For:” and “Weighting Factor”). The weighting of each Outcome Type is determined by algorithmic and expert panel consideration of the amount of change exhibited by recent changes to the actual data measurements for each disease. Therefore, this volatility factor is unique to each HOI and has an impact on the HOI formula to determine and establish the appropriate weight for each Outcome Type of a HOI. In the case of the exemplary HOI for Diabetes, the weighting factor for the Economic Outcome Type has a value of 10%. This relatively low weighting factor is selected because the data values over the previous two measurement periods did not significantly change. This lack of a significant change is the result of the fact that coverage for Diabetes is fairly stable (meaning that there is little, if any, change in the reimbursement and payment of the Drug, Facility and Provider components of the Economic Outcome Type). A similar calculus is performed for each Outcome Type. In the exemplary HOI for Diabetes, this calculus results in an Outcome Type Weighting Factor for the Economic Outcomes at a value of 10%, Clinical Outcomes at 70% and Humanistic Outcomes at 20%. In this respect, the Outcome Type Weighting Factors reflect the relative importance of each outcome type in the HOI at issue. An algorithm is created for each Outcome Type. The algorithm is produced through research and analysis by an expert panel. The actual data for each Data Type is passed through the respective algorithm and a Normalized Data Measurement is produced for each Data Type. The Normalized Data Measurements are then adjusted according to the Data Type Weighting Factors and Outcome Type Weighting Factors, pursuant to the HOI formula. Thereafter, the HOI is produced. For the exemplary HOI for Diabetes, as identified in FIG. 12, once the Normalized Data Measurements are adjusted pursuant to the Data Type Weighting Factors and Outcome Type Weighting Factors, the resulting HOI equals 1.44.

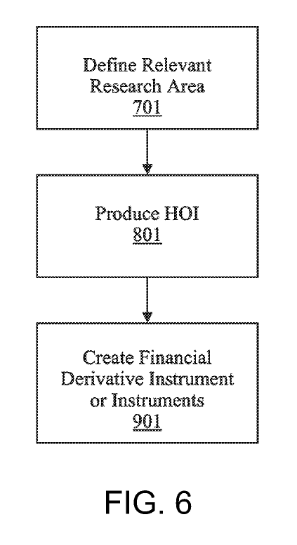

FIG. 7 depicts an apparatus that is used to create a HOI. The apparatus is comprised of a computing device 345 capable of having data 315, 325 and 335 being inputted into the device. For instance, data related to the three components of a particular HOI—which include economic data 315, clinical data 325 and humanistic data 335—may be inputted into a computing device 345. The data may be inputted directly by a user of the computing device 345 or through a link to an outside source or sources. For instance, the computing device 345 may be linked to one or more distinct data sources, such as outside computing devices, which provide input data related to economic data 315, clinical data 325 and humanistic data 335. The external devices may be linked via any communications channel, such as the Internet or other communications link.

Once the computing device 345 has collected the external data, the device 345 manipulates and transforms the data in such a way as to create a particular HOI. Such manipulation is pursuant to the steps outlined in FIG. 1. The computing device 345 then outputs a figure that represents the HOI 355. The output 355 may be communicated, via any available means, to a third party. This output 355 produces a tangible result and provides a useful purpose insofar as the computing device 345 creates a figure by manipulating the data from the outside sources, the figure not being in existence prior to the manipulation by the computing device 345.

At its core, each HOI is based on real-world clinical evaluations of individuals. For each individual, the clinical evaluation is a measurement of chemical properties in that individual's body. The chemical properties are then identified to clinicians as quantitative or qualitative representations. Health care providers then use these quantitative and qualitative representations to diagnose individual patients and make health care decisions. Each HOI aggregates these representations, applies statistical modeling and produces a summary value, or index, that tracks changes in clinical evaluations. As such, each HOI transforms raw medical data from individuals into a dynamic index that can be used to measure and track the burden of disease over time. Moreover, each HOI may then be used in making decisions by various players in the health care industry, such as payers, providers and patients, at both the micro and macro levels.

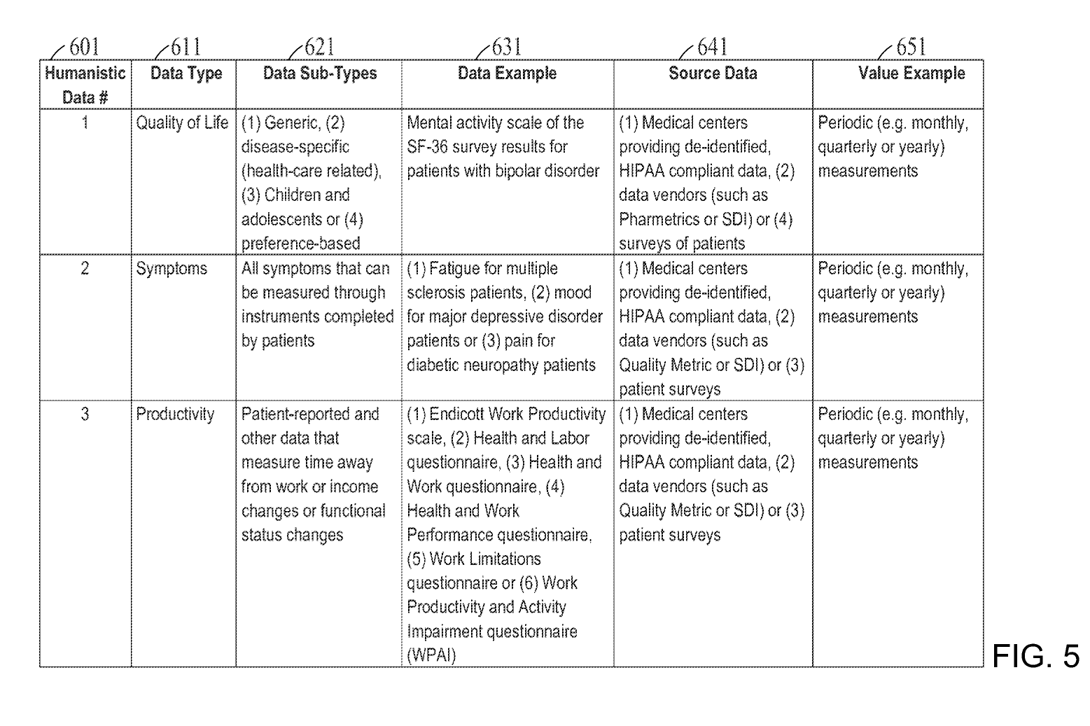

In addition to creating any number of HOIs, a system, method, and apparatus are provided in accordance with one or more embodiments for creating any number of financial derivative instruments that may be based on each HOI. As depicted in FIG. 6, a relevant research area is determined at 701. Utilizing the steps outlined in FIG. 1, a HOI is then produced at 801. A financial derivative instrument or instruments may then be created at 901, based on a particular HOI produced at 801. The creation of a financial derivate instrument, based upon an index, is a process known in the art. Derivatives are financial contracts, or financial instruments, whose values are derived from the value of something else (known as the underlying). The underlying value on which a derivative is based can be an asset (e.g., commodities, equities (stocks), residential mortgages, commercial real estate, loans, bonds), an index (e.g., interest rates, exchange rates, stock market indices, consumer price index (CPI), weather conditions, or other items. Credit derivatives are based on loans, bonds, or other forms of credit. Derivatives can be used to mitigate the risk of economic loss arising from changes in the value of the underlying. This activity is known as hedging. Alternatively, derivatives can be used by investors to increase the profit arising if the value of the underlying moves in the direction they expect. This activity is known as speculation. The main types of derivatives are forwards, futures, options, and swaps. Financial derivatives, and the trading of futures contracts based on the derivatives, are used by prominent financial organizations such as the U.S.'s Chicago Mercantile Exchange, Europe's Eurex, and Singapore's Singapore Mercantile Exchange for the purpose of providing risk management, hedging, and speculative trading capabilities to the financial community. Examples of these derivatives include contracts based on equities (e.g., S&P500, Dow Jones Euro STOXX Sector Index Futures), metals (e.g., Gold and Silver Derivatives), energy (e.g., Light Crude Oil, Natural Gas), agriculture (e.g., Corn, Wheat, Pork Bellies, Orange Juice), and weather (e.g., Hurricane Futures). In generally every country where a formal commodities market exists, there also exists a governing body to that market, for example in the United States it is the CFTC (Commodity Futures Trading Commission).

By way of first example, a futures contract may be based upon a HOI. The futures contract may then be traded on a futures market or other exchange. The placement of HOI futures contracts on a futures market or other exchange will permit the trading of contracts in health outcomes. By way of second example, the HOI itself may serve as a financial instrument that may be directly traded, traded through subscription or invested in by any means as known in the art.

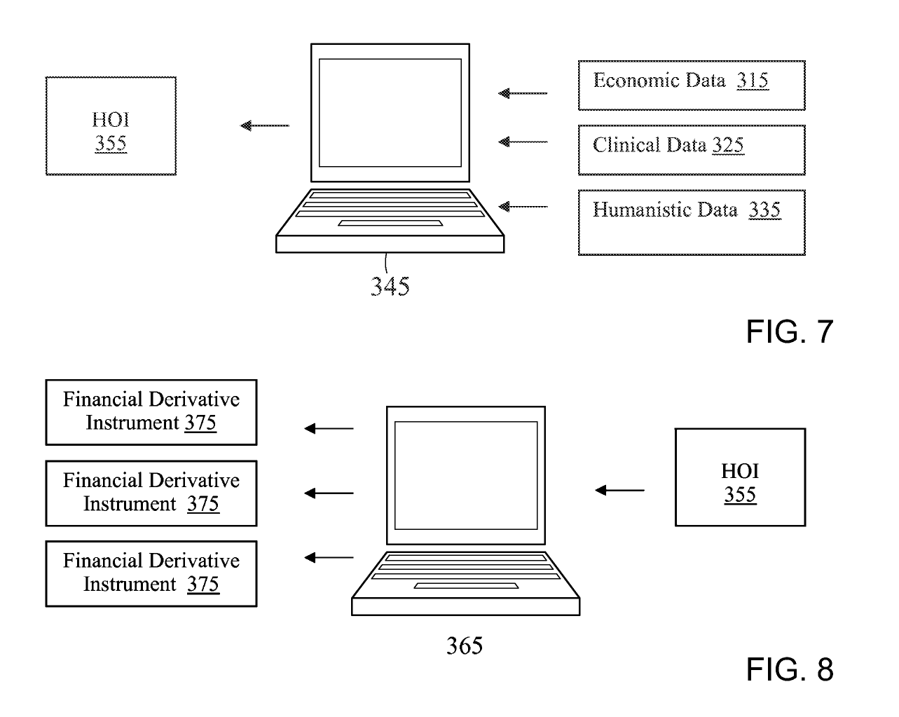

FIG. 8 depicts an apparatus that is used to create a HOI financial derivative instrument or instruments. The apparatus is comprised of a computing device 365 capable of having one or more HOIs 355 being inputted into the device. FIG. 8 depicts only one HOI being inputted into the computer device 365. However, in accordance with one or more embodiments, one or more HOIs 355 may be utilized to create a financial derivative instrument or instruments. The HOI 355 may be inputted directly by a user of the computing device or through a link to an outside source or sources. For instance, the computing device may be linked to one or more distinct HOI sources, such as other computing devices, which provide the HOI or HOIs to be utilized in the creation of a financial derivative instrument or instruments. The other devices may be linked via any communications channel, such as the internet or other communications link.

Once the computing device 365 has collected the external data, the device 365 manipulates and transforms the data in such a way as to create a particular HOI financial derivative instrument or instruments. Techniques for creating financial derivative instruments are known in the art. The computing device 365 then outputs a figure or figures that represent the HOI financial derivate instrument or instruments 375. The output 375 may be communicated, via any available means, to a third party. This output 375 produces a tangible result and provides a useful purpose insofar as the computing device 365 creates a figure that represent the HOI financial derivate instrument or instruments 375 by manipulating and transforming the HOI 355 from an outside source, the figure 375 not being in existence prior to the manipulation by the computing device 365.

Various embodiments seek to go beyond general health care costs, and can be based upon the underlying factors that impact health outcomes, including, but not limited to, diseases, quality of life, geographic variations, research and development, standard of care, medicines, public policy, health insurance premiums, utilization management, disease management, socio-economic status, race, gender and education level.

Among those who can benefit from HOIs and HOI financial derivative instruments are healthcare industry organizations or entities with interest and investments in healthcare. Such organizations, which include but are not limited to, pharmaceutical and biotech companies, insurance companies, hospitals, nursing homes, unions, pensions, academia, sovereign wealth funds and state and federal governments, continuously make major financial decisions of whether to develop major new products or services or fund and/or invest in healthcare. These parties currently utilize various methods of valuing their investments, and use the economics of their valuation to decide whether a new product or service will lead to profitability.

HOIs and HOI financial derivative instruments in accordance with various embodiments permit a free-market measurement and hedging by creating a dynamically changing indices based on new information that becomes known about the impact of new products (such as pharmaceuticals and biologics) and services (such as disease management programs for chronic diseases), and a method by which to invest in financial derivative instruments of HOIs based on the needs of the industry. Consumers and other interested parties can be provided with access to a larger amount of effective products and services that improve their health outcomes. A product is also provided by which health care considerations can be objectively valued on a free-market exchange.

Accordingly, the healthcare industry can reduce risk in the development and/or delivery of products and/or services by purchasing financial derivative instruments, for example, that are organized by disease or drug class and valued pursuant to the health outcome commodity index disclosed herein. This hedging is possible due to the method by which a HOI permits others to purchase financial derivative instruments based on changing market conditions of health outcomes. Indeed, the financial benefits of hedging and futures contracts are well known to one of ordinary skill in the art.

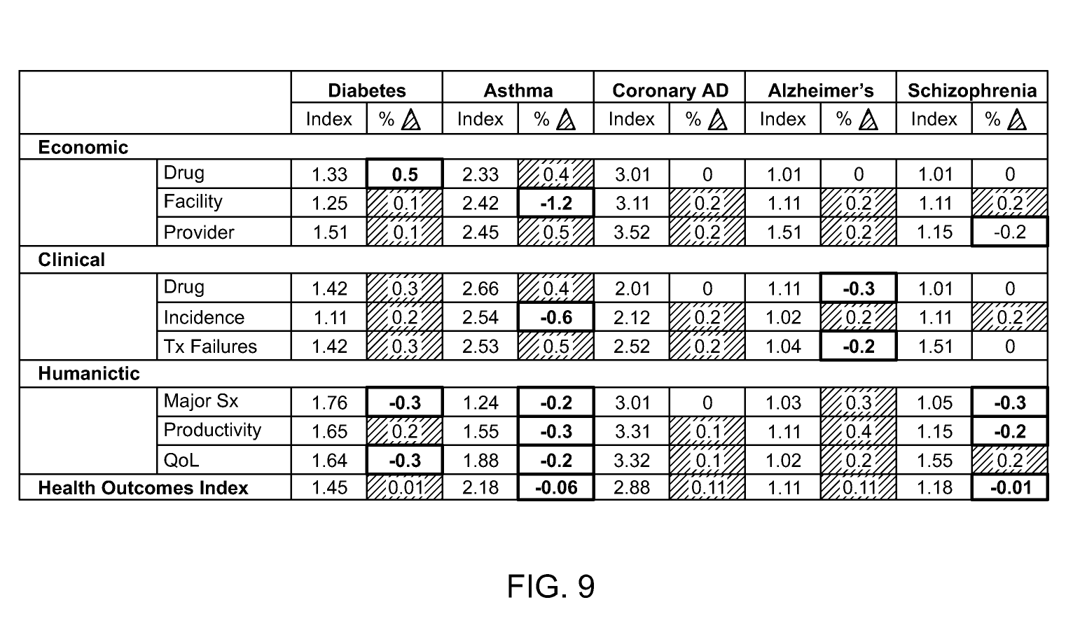

By way of example, FIG. 9 is a weekly measurement showing the values along with percent change from previous measurement for the economic, clinical, and humanistic outcomes for various diseases. FIG. 9 further shows a HOI for various diseases that is based on a combination of each of the economic, clinical, and humanistic outcomes. The chart of FIG. 9 can be generated by the computer 345 or another computer transforming the HOI generated by the computer 345.

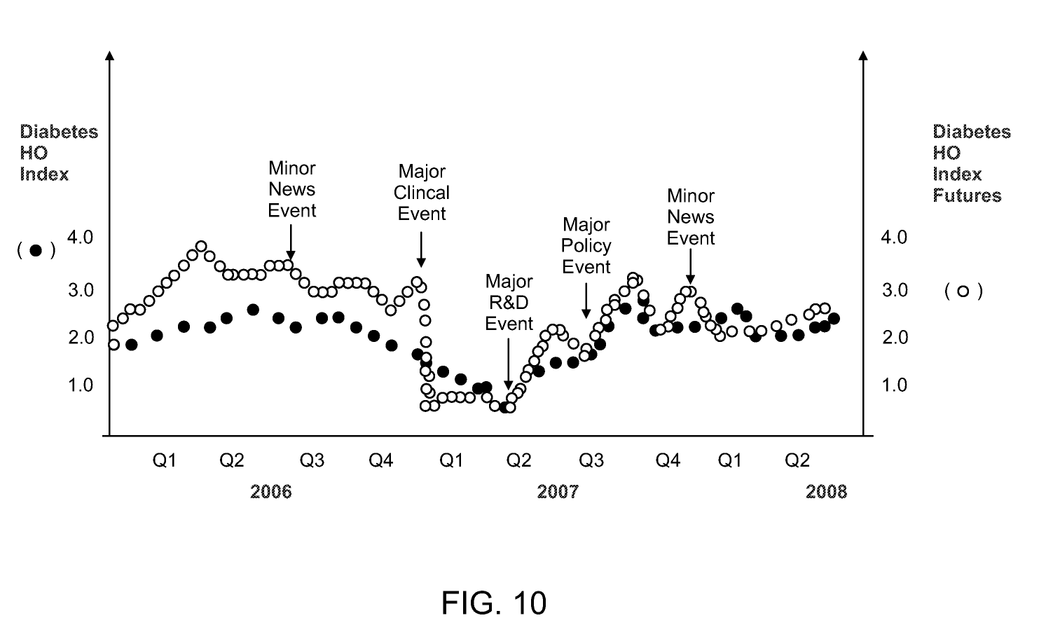

By way of further example, FIG. 10 is an overlay of two graphs, a time series of a HOI for Diabetes (labeled “Diabetes HO Index”) and graph depicting a predictive HOI for Diabetes. (labeled “Diabetes HO Index Futures”). The predictive HOI is subject to volatility due to the anticipation of how future health outcomes will be affected by factors including, but not limited to, news, clinical, policy, or research and development events. The graph of FIG. 10 can be generated by the computer 345 or another computer transforming the HOI generated by the computer 345.

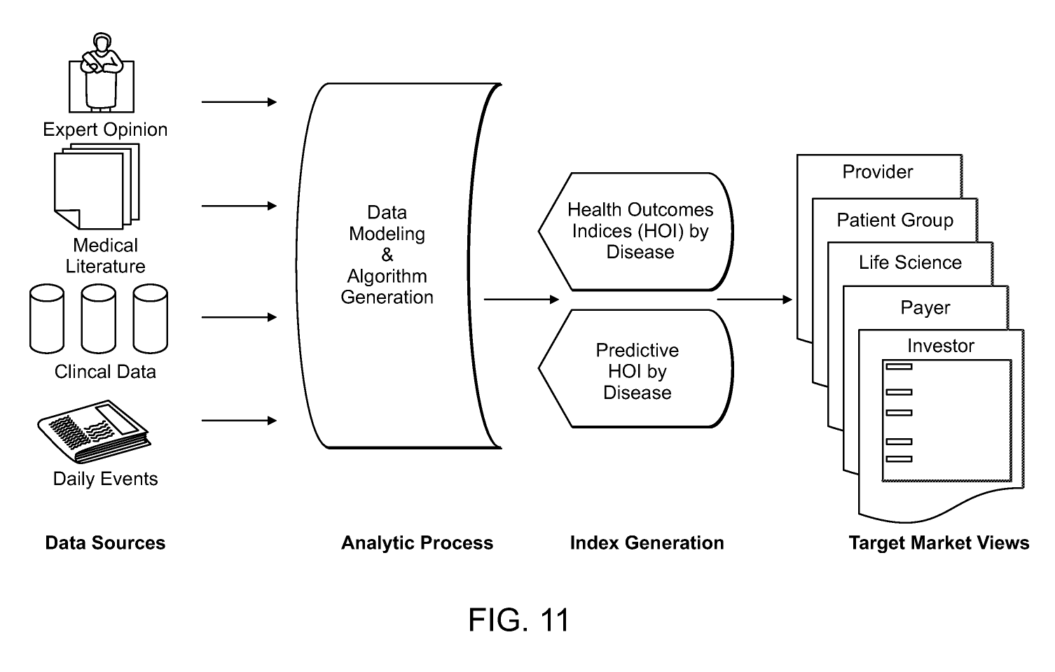

By way of further example, FIG. 11 depicts a method of creating and utilizing a HOI. At the onset, any number of data sources may be taken into consideration. Once these data sources are selected, they are fed into the algorithm and data modeling process. Once data modeling is complete, a health outcomes index, and/or a predictive health outcomes index, is created. The indices may then be utilized by a number of target markets in the health care industry. Target markets include, but are not limited to: (1) Providers, who can compare local outcomes with national benchmarks and document competitive management of diseases; (2) Patient Groups, who can demonstrate ethnic and regional differences in health care and direct investments accordingly; (3) Life Science organizations, who can track subpopulations of diseases and structure investments accordingly; (4) Payers, who can reward better outcomes and track compliance in disease management; and (5) Investors, who can follow trends that effect companies and accordingly structure investment decisions.

The computer implemented techniques described above for generating HOIs and financial derivative instruments based on one or more HOIs may be implemented in hardware, software, firmware, or any combination thereof. The techniques described above may be implemented in one or more computer programs executing on a programmable computer including a processor, a storage medium readable by the processor (including, for example, volatile and non-volatile memory and/or storage elements), at least one input device, and at least one output device. Program code may be applied to input data entered using the input device to perform the functions described and to generate output. The output may be provided to one or more output devices.

Each computer program within the scope of the claims below may be implemented in any programming language including, e.g., assembly language, machine language, a high-level procedural programming language, or an object-oriented programming language. The programming language may, e.g., be a compiled or interpreted programming language.

Each such computer program may be implemented in a computer program product tangibly embodied in a machine-readable storage device for execution by a computer processor. Method steps of the invention may be performed by a computer processor executing a program tangibly embodied on a computer-readable medium to perform functions of the invention by operating on input and generating output. Suitable processors include, by way of example, both general and special purpose microprocessors. Generally, the processor receives instructions and data from a read-only memory and/or a random access memory. Storage devices suitable for tangibly embodying computer program instructions include, but are not limited to, a hard disk drive or a removable memory such as an optical disk or a flash drive.

It is to be understood that although the invention has been described above in terms of particular embodiments, the foregoing embodiments are provided as illustrative only, and do not limit or define the scope of the invention. Various other embodiments are also within the scope of the claims. For example, elements and components described herein may be further divided into additional components or joined together to form fewer components for performing the same functions.

Method claims set forth below having steps that are numbered or designated by letters should not be considered to be necessarily limited to the particular order in which the steps are recited.

What is claimed is:

1. A computer-implemented method of generating and utilizing a health outcome index for a given research interest area and a given population, the computer-implemented method comprising the steps of:
(a) receiving data relating to one or more given criteria pertinent to the research interest area;
(b) calculating a health outcomes index using one or more computer processes applying a given formula to the data relating to the one or more given criteria, said given formula including assignment of relative weights to said one or more criteria;
(c) outputting the health outcome index; and
(d) periodically repeating steps (a) through (c).

2. The computer-implemented method of claim 1 wherein said one or more given criteria include economic factors.

3. The computer-implemented method of claim 1 wherein said one or more given criteria include clinical factors.

4. The computer-implemented method of claim 1 wherein said one or more given criteria include humanistic factors.

5. The computer-implemented method of claim 1 further comprising creating one or more financial derivative instruments based on the health outcomes index.

6. The computer-implemented method of claim 1 further comprising providing the health outcomes index to a healthcare provider for use in treating a patient.

7. The computer-implemented method of claim 1 further comprising providing the health outcomes index to a payor or healthcare provider for use in making reimbursement, coverage, treatment, or payment decisions in the healthcare industry.

8. The computer-implemented method of claim 1 further comprising transmitting the health outcomes index to a party for use in making investment decisions in the healthcare industry.

9. The computer-implemented method of claim 1 further comprising transmitting the health outcomes index to a party for use in conducting comparative effectiveness research.

10. The computer-implemented method of claim 1 further comprising transmitting the health outcomes index to a party for use in hedging risks in the healthcare industry.

11. The computer-implemented method of claim 1 wherein the given research interest area comprises a disease, a therapeutic area, a drug class, a genotype, an RNA type, a protein type, or a medical or biologic technology.

12. The computer-implemented method of claim 1 further comprising creating the given formula before step (b).

13. The computer-implemented method of claim 1 further comprising periodically recalibrating the given formula.

14. A computer program product for generating and utilizing a health outcome index for a given research interest area and a given population, the computer program product residing on a computer readable medium having a plurality of instructions stored thereon which, when executed by a processor, cause that processor to:
(a) receive data relating to one or more given criteria pertinent to the research interest area;
(b) calculate a health outcomes index using one or more computer processes applying a given formula to the data relating to the one or more given criteria, said given formula including assignment of relative weights to said one or more criteria;
(c) output the health outcome index; and
(d) periodically repeat (a) through (c).

15. The computer program product of claim 14 wherein said one or more given criteria include economic factors.

16. The computer program product of claim 14 wherein said one or more given criteria include clinical factors.

17. The computer program product of claim 14 wherein said one or more given criteria include humanistic factors.

18. The computer program product of claim 14 further comprising instructions for creating one or more financial derivative instruments based on the health outcomes index.

19. The computer program product of claim 14 further comprising instructions for providing the health outcomes index to a healthcare provider for use in treating a patient.

20. The computer program product of claim 14 further comprising instructions for providing the health outcomes index to a payor or healthcare provider for use in making reimbursement, coverage, treatment, or payment decisions in the healthcare industry.

21. The computer program product of claim 14 further comprising instructions for transmitting the health outcomes index to a party for use in making investment decisions in the healthcare industry.

22. The computer program product of claim 14 further comprising instructions for transmitting the health outcomes index to a party for use in conducting comparative effectiveness research.

23. The computer program product of claim 14 further comprising instructions for transmitting the health outcomes index to a party for use in hedging risks in the healthcare industry.

24. The computer program product of claim 14 wherein the given research interest area comprises a disease, a therapeutic area, a drug class, a genotype, an RNA type, a protein type, or a medical or biologic technology.

25. The computer program product of claim 14 further comprising instructions for creating the given formula before step (b).

26. The computer program product of claim 14 further comprising instructions for periodically recalibrating the given formula.

27. A computer system for generating and utilizing a health outcome index for a given research interest area and a given population, the computer system comprising:
an input for receiving data relating to one or more given criteria pertinent to the research interest area;
one or more processors for calculating a health outcomes index by applying a given formula to the data relating to the one or more given criteria, said given formula including assignment of relative weights to said one or more criteria; and
an output for outputting the health outcome index.

28. The computer system of claim 27 wherein said one or more given criteria include economic factors.

29. The computer system of claim 27 wherein said one or more given criteria include clinical factors.

30. The computer system of claim 27 wherein said one or more given criteria include humanistic factors.

31. The computer system of claim 27 wherein the one or more processors further create one or more financial derivative instruments based on the health outcomes index.

32. The computer system of claim 27 wherein the computer system provides the health outcomes index to a healthcare provider for use in treating a patient.

33. The computer system of claim 27 wherein computer system provides the health outcomes index to a payor or healthcare provider for use in making reimbursement, coverage, treatment, or payment decisions in the healthcare industry.

34. The computer system of claim 27 wherein the computer system transmits the health outcomes index to a party for use in making investment decisions in the healthcare industry.

35. The computer system of claim 27 wherein the computer system transmits the health outcomes index to a party for use in conducting comparative effectiveness research.

36. The computer system of claim 27 wherein the computer system transmits the health outcomes index to a party for use in hedging risks in the healthcare industry.

37. The computer system of claim 27 wherein the given research interest area comprises a disease, a therapeutic area, a drug class, a genotype, an RNA type, a protein type, or a medical or biologic technology.

38. The computer system of claim 27 wherein the one or more processors further create the given formula before applying the formula.

39. The computer system of claim 27 wherein the one or more processors further periodically calibrate the given formula.
